(19) United States
(12) Patent Application Publication
(10) Pub. No.: US 2002/0047056 A1
(43) Pub. Date: Apr. 25, 2002

(54) Electrostatic spray gun having needle electrode made from nickel titanium alloy

(76) Inventors: Michael J. Reget, Plymouth, MN (US); Mark M. Kiviahde, Monticello, MN (US); Richard D. Anderson, Maple Grove, MN (US)

Correspondence Address: Douglas B. Farrow, Esquire, Corporate Intellectual Property Counsel, Graco Inc., P.O. Box 1441, Minneapolis, MN, 55440-1441, US

(21) Appl. No.: 09/964,028

(22) Filed: Sep. 25, 2001

Related U.S. Application Data
(60) Provisional application No. 60/238,672, filed on Oct. 6, 2000.

(51) Int. Cl. B05B 5/00

(52) U.S. Cl. 239/706

(57) ABSTRACT

An electrostatic spray gun 10 has a needle electrode 14 made from a nickel titanium alloy.

This application is a continuation-in-part of U.S. Application Ser. No. 60/238,672, filed Oct. 6, 2000.

### TECHNICAL FIELD

Electrostatic spray guns have been used in the industry for many years.

### BACKGROUND ART

Such designs are typified by U.S. Pat. Nos. (4,241,880 & 4,335,851, 4,290,091, 4,377,838 and 4491276), the contents of which are hereby incorporated by reference. One feature common to most of the prior art spray guns is that they use a needle electrode extending to the air cap of the spray guns to charge the material (typically paint) being sprayed. Such electrodes are typically formed using wires such as stainless steel and music wire which will typically take on a new shape when bent. Such a bent electrode can deform the spray pattern causing poor material finish quality and after several bends, these electrodes tend to break off thereby greatly reducing the electrostatic charging imparted to the material being sprayed.

### DISCLOSURE OF THE INVENTION

An electrostatic gun electrode is conducted using a nickel titanium alloy needle which is molded into the part. The properties of this material include its shape memory and elasticity which allows substantial elastic defamation from an external force and yet allow the electrode to return to its original shape and position. Such an electrode also has a higher resistance than needle electrodes formed of the prior art materials which can serve to reduce undesired arching from the needle.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 shows the cross-section of a typical electrostatic spray gun having a needle electrode.

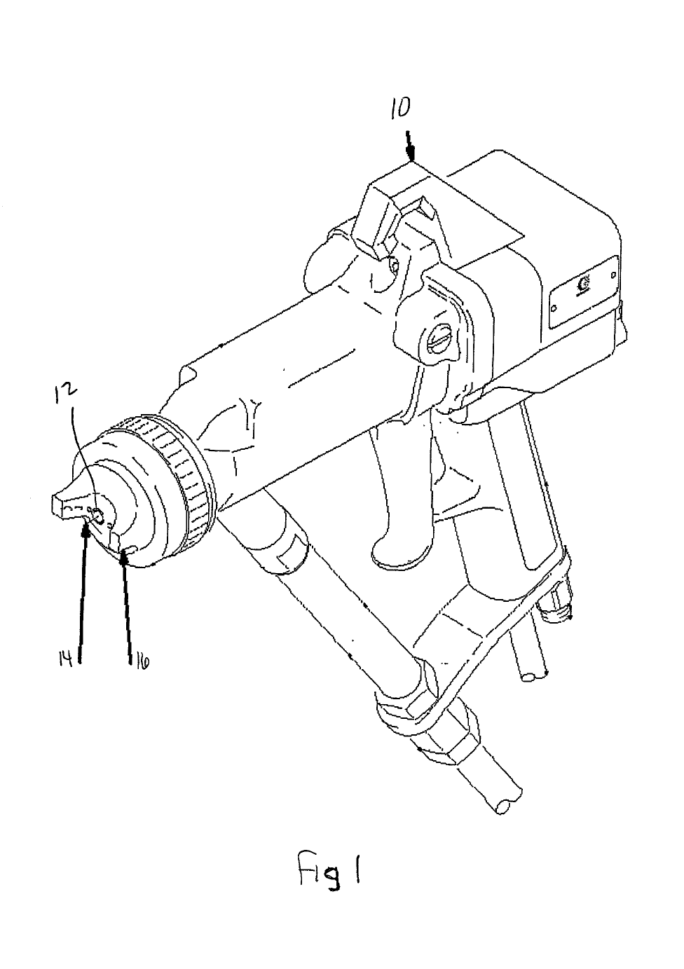

### BEST MODE FOR CARRYING OUT THE INVENTION

In the instant invention shown in electrostatic spray gun, generally designated 10, the electrode 12 consists of an injection-molded plastic part having the nickel titanium needle 14 molded into the part. The geometry of such a needle is generally the same, that is, it should extend from the front of the spray gun approximately the same distance as a needle made of more conventional materials depending on the geometry of the air cap 16 and other spray gun specific parameters. In the preferred embodiment a Code N alloy needle is preferred and has a length of 0.43 inches (from the front of the air cap) and a diameter of 0.020 inches.

It is contemplated that various changes and modifications may be made to the electrostatic spray gun without departing from the spirit and scope of the invention as defined by the following claims.

1. In an electrostatic spray gun having a needle electrode and an air cap, the improvement comprising said needle electrode being formed of a nickel titanium alloy.
